(19) United States
(12) Patent Application Publication
(10) Pub. No.: US 2003/0051897 A1
(43) Pub. Date: Mar. 20, 2003

(54) Mini coaxial cable for digital network

(75) Inventors: Denis Blouin, Pierrfond (CA); Joel Bernard, Montreal (CA); Yves Dion, Boucherville (CA)

Correspondence Address: Gary S. Engelson, Wolf, Greenfield & Sacks, P.C., 600 Atlantic Avenue, Boston, MA, 02210, US

(73) Assignee: Nordx/CDT, Inc., Pointe-Claire (CA)

(21) Appl. No.: 10/245,450

(22) Filed: Sep. 17, 2002

Related U.S. Application Data
(60) Provisional application No. 60/322,641, filed on Sep. 17, 2001.

(51) Int. Cl. H01B 7/18

(52) U.S. Cl. 174/106 R

(57) ABSTRACT

A coaxial cable compatible with standard 735 type performance parameters has a smaller diameter and greater flexibility at a lower cost.

### CROSS-REFERENCED TO RELATED APPLICATION

The present application claims domestic priority under 35 U.S.C. §119(e) to copending U.S. provisional patent application serial No. 60/322,641 filed Sep. 17, 2001, incorporated herein by reference.

### BACKGROUND OF THE INVENTION

1. Field of the Invention

The present invention relates to coaxial cables. More particularly, the present invention relates to miniature coaxial cables used in digital signal transmission applications, such as in telephone switching applications.

2. Related Art

In some digital communication networks, certain digital signals are carried from one piece of central office equipment to another on miniature coaxial cables. In North America, standards for such cables have been set by Bell Communications Research, Inc. (“Bellcore”), the former Central Services Organization of AT&T, spun off during the 1984 divestiture, and now operating as Telcordia Technologies (“Telcordia”). The most common types of digital signals carried by coaxial cables are produced by so-called DS3 and STS-1 signal sources.

One standard promulgated by Telcordia is GR-139-CORE, “Generic Requirements for Central Office Coaxial Cable”, Issue 1, October 1996, incorporated herein by reference. Among other things, with respect to electrical parametric requirements Telcordia GR-139-CORE defines a cable having a 75 ohm characteristic impedance referred to as 735 coaxial cable, which is suitable for connecting a digital source and a digital receiver less than 225 feet apart. The construction of conventional 735 coaxial cable as shown in FIG. 1, is now described.

Conventional 735 coaxial cable 100 has a 26 AWG silver-plated copper center conductor 101. The center conductor 101 is surrounded by several successive layers of materials in the order recited.

The center conductor is surrounded by a high density polyethylene (HDPE) foam with a blow ratio of about 37% and an outer diameter of about 0.077 inches, an inner shield 103 of 0.002 inches of aluminum on 0.001 inches of polyester tape, an outer shield 104 of flat bundles of 6 strands of 38 AWG tinned copper braided to provide a 90% coverage and a polyvinyl chloride (PVC) outer jacket 105. The structure has an outer diameter of 0.129 inches. A bundle of twelve conventional 735 coaxial cables 100, enclosed in an outer PVC jacket 201 is shown in FIG. 2. This construction has an outer diameter of 0.600″.

### SUMMARY OF THE INVENTION

According to one embodiment, the invention comprises a miniature coaxial cable having a characteristic impedance of about 75 ohms, comprising: a center conductor having an outer diameter of about 0.0159 inches, a first dielectric layer disposed about the center conductor having a dielectric constant less than about 1.7 and an outer diameter less than about 0.077 inches, a conductive tape including a second dielectric layer less than 0.001 inches thick on which is disposed a metal layer less than 0.002 inches thick where the conductive tape is applied to the first dielectric layer such that the second dielectric layer is adjacent to it, a braided conductor disposed about and in contact with the metal layer of the conductive tape, and an insulating jacket disposed about the braided conductor.

In another embodiment, the invention comprises a miniature coaxial cable with a characteristic impedance of about 75 ohms, including: a center conductor, a dielectric layer having a dielectric constant value of less than 1.7, an outer conductor structure, and a jacket; wherein the outside diameter of the miniature coaxial cable is less than 0.122 inches.

In a further embodiment, the invention comprises a bundle of coaxial cables enclosed in a jacket, wherein the coaxial cables enclosed are miniature coaxial cables which meet the GR-139-CORE (Issue 1, 1996) standard having a characteristic impedance of 75 ohms and wherein a miniature cable includes a center conductor, a dielectric layer having a dielectric constant value of less than 1.7, an outer conductor structure, and a jacket, wherein the outside diameter of the miniature coaxial cable is less than 0.122 inches.

### BRIEF DESCRIPTION OF THE DRAWINGS

In the drawings, in which like reference designations indicate like elements:

FIG. 3 is a cross sectional view of a coaxial cable embodying one aspect of the invention;

FIG. 4 is a cross sectional view of a bundled cable of coaxial cables embodying another aspect of the invention;

FIG. 1 is a cross sectional view of a conventional coaxial cable;

FIG. 2 is a cross sectional view of a bundled cable of conventional coaxial cables;

FIG. 5 is a perspective view of peeled-back layers of the cable of FIG. 1 in which a conductive tape is applied longitudinally; and

FIG. 6 is a perspective view of peeled-back layers of the cable of FIG. 1 in which a conductive tape is applied spirally.

### DETAILED DESCRIPTION

The present invention will be better understood upon reading the following detailed description of various embodiments and aspects thereof, in connection with the figures.

Embodiments of aspects of the present invention can replace conventional 735 cables at a lower production cost and take up less space in existing cable trays and runs than the conventional 735 cable replaced. The invention meets the afforementioned Telcordia GR-139-CORE 735 cable standard. The invention is suitable for carrying digital signals for at least 223 feet and up to about 225 feet. It can be used to carry DS3 and STS-1 digital signals, as well as other digital and analog signals of similar spectral bandwidth. An example use for such cable is in central office applications.

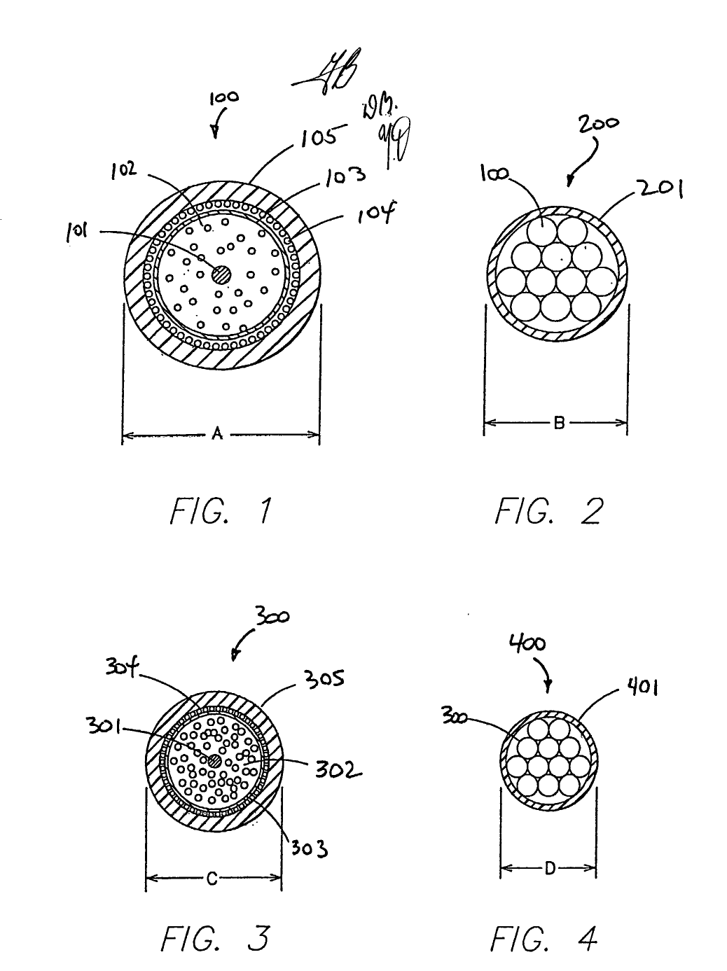

The center conductor 301 of the exemplary cable 300 shown in FIG. 3 is a 26 AWG silver plated copper wire. This wire has an outside diameter of between 0.0157 and 0.0162 inches. The particular materials and dimension of the center conductor 301 are selected to have a conductivity which limits at which permits run lengths of at least 223 feet and up to about 225 feet for DS-3 signals. The center conductor 301 may be constructed of wire having a different base material and/or plating, or of unplated wire known in the art to have an adequate conductivity for the purpose. As is known, other construction can provide the same or other conductivities, as may be desired.

The center conductor 301 is surrounded by a dielectric material 302 having a dielectric constant, ∈, less than or equal 1.7, and an outer diameter less than 0.077 inches. The dielectric 302 may be formed of a polyolefin. An example of a polyolefin suitable for use is a foamed high density polyethylene (HDPE) material having a blow ratio greater than 37%. In a particular exemplary embodiment, the dielectric is HDPE foamed with a blow ratio of 45%, resulting in an outer diameter of 0.073 inches.

Foamed HDPE can be made by chemical foaming or by gas injection foaming. Chemical foaming is used in the exemplary embodiment because it can be used in conventional coating equipment, without the addition of gas injection facilities.

Other materials can be used in place of the HDPE foam. For example, fluorinated ethylene propylene (FEP) could be used, yielding a smaller outer diameter, in order to maintain the characteristic impedance desired of about 75 ohms. However, foamed HDPE is a low cost material presently available for this application.

In this cable, there is a relationship between the inner diameter, d, the outer diameter, D, the desired characteristic impedance, Z, and the dielectric constant of the foamed HDPE, ∈ᵣ, which governs. Namely,

$$Z := \frac{138}{\sqrt{{ϵ}_{r}}} log ( \frac{D}{d} ) \qquad ( 1 )$$

or, the outer diameter desired, D, is:

$$D = d \cdot {10}^{\frac{Z \sqrt{{ϵ}_{r}}}{138}} \qquad ( 2 )$$

It is well known that foamed HDPE, at a blow ratio of 37% has ∈ᵣ=1.7.. In contrast, at a blow ratio of 45%, ∈ᵣ=1.5. The value of ∈ᵣ varies with blow ratio, hence for fixed d and Z, D must vary accordingly.

Surrounding the dielectric layer 302 is an outer conductor structure including an inner shield formed of a conductive tape 303 and an outer shield formed of a braided conductor 304. The conductive tape 303 is constructed of a layer of polyester less than 0.001 inches thick on which is disposed a metal layer less than 0.002 inches thick. The conductive tape 303 may be applied to the outside of the dielectric layer 302 longitudinally, as shown in FIG. 5, with or without overlap applied in a spiral fashion, as shown in FIG. 6, also with or without overlapping seams 501. An edge of the conductive tape may be folded under 502, as shown in FIGS. 5 and 6, so as to provide continuous contact along the longitudinal or spiral seams 501.

In the exemplary embodiment, the polyester film has a thickness of about 0.00045 inches thick and the conductive metal layer is about 0.001 inches thick of aluminum. The aluminum layer can be as thin as 0.0005 inches thick, if desired.

The outer shield of braided conductor 304 of the exemplary embodiment is constructed of flat bundles of six strands each of 38 AWG tin plated copper, braided to provide 95% coverage, in the manner known to the skilled artisan. The outer conductor structure 304 brings the outside diameter of the coaxial cable to 0.092 inches in diameter. Finally, a jacket 305 of any suitable material is applied to the cable, bringing the total diameter 0.114 inches. PVC is an example of suitable material from which to form the jacket. The outer jacket 305 can be treated, for example by fluorination, or other materials can be selected for the outer jacket 305 to meet various structural, wear and fire resistance requirements as may be desired.

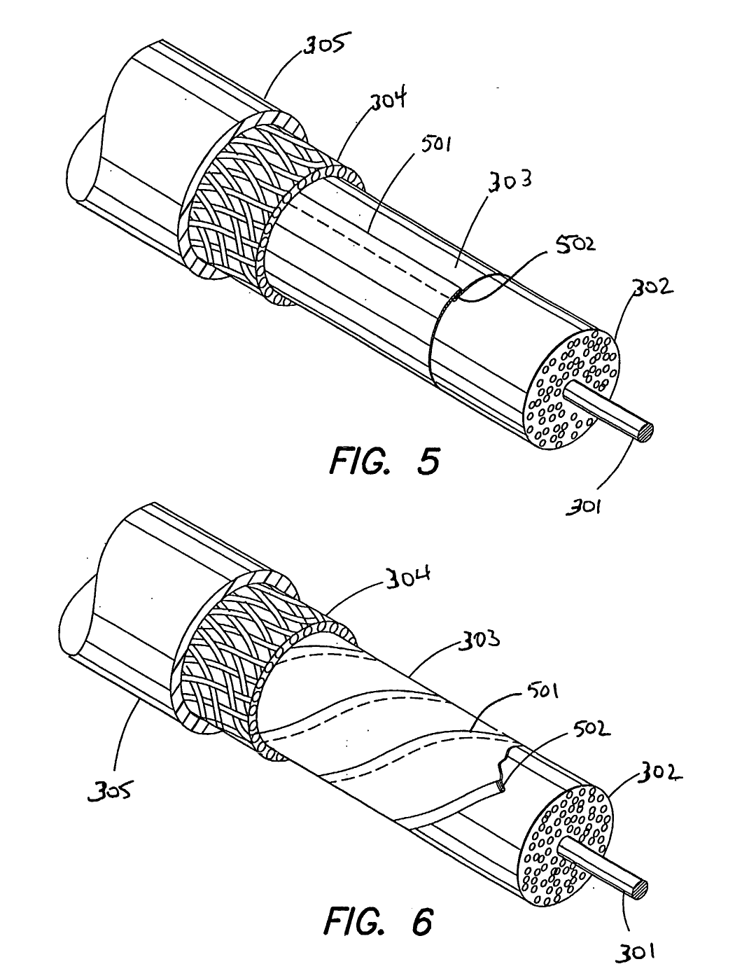

As shown in FIG. 4, a bundle of 12 cables 300 according to the above-described embodiment can be further surrounded by a jacket 401 of PVC or any other suitable material, producing a bundled cable of 0.515 inches diameter. The cross-sectional area of such a cable is 0.209 square inches. The resulting dimensions of this cable 400 are significantly smaller than those of a similar performing conventional cable (FIG. 2, 200). Moreover, the individual coaxial cables 300 and the bundle 400 described herein are substantially more flexible than conventional cable (FIG. 1, 100) and bundle (FIG. 2, 200), as a result of the higher blow ratio and thinner outer conductive structure. For example, the minimum radius of the individual coaxial cable described above is at most 10 times its diameter.

The present invention has now been described in connection with a number of specific embodiments thereof. However, numerous modifications which are contemplated as falling within the scope of the present invention should now be apparent to those skilled in the art. The features of this invention in connection with the various embodiments can all be combined and recombined in various ways. Therefore, it is intended that the scope of the present invention be limited only by the scope of the claims appended hereto.

What is claimed is:

1. A miniature coaxial cable having a characteristic impedance of about 75 ohms which substantially meets GR-139-CORE (Issue 1, 1996) specifications with respect to electrical parametric requirements, comprising:
a center conductor having an outer diameter of about 0.0159 inches;
a first dielectric layer disposed about the center conductor, having a dielectric constant less than about 1.7 and an outer diameter less than about 0.077 inches;
a conductive tape including a second dielectric layer less than 0.001 inches thick on which is disposed a metal layer less than 0.002 inches thick, the conductive tape applied to the first dielectric layer with the second dielectric layer adjacent the first dielectric layer;
a braided conductor disposed about and in contact with the metal layer of the conductive tape; and
an insulating jacket disposed about the braided conductor.

2. The cable of claim 1, wherein the second dielectric layer is formed of polyester.

3. The cable of claim 1, wherein the second dielectric layer is formed of fluorinated ethylene propylene.

4. The cable of claim 1, wherein the first dielectric layer further comprises a high density polyethylene foam having a blow ratio of between 37% and 45% and a diameter between 0.77 inches and 0.72 inches.

5. The cable of claim 1, wherein the jacket is a PVC jacket.

6. The cable of claim 1, wherein the cable is adapted to be terminated by a 735A connector.

7. The cable of claim 1, wherein the minimum bend radius of the cable is at most 1.22 in.

8. The cable of claim 1, wherein the first dielectric layer includes a polyolefin.

9. The cable of claim 8, wherein the polyolefin of the first dielectric layer is formed of a polypropylene.

10. The cable of claim 8, wherein the polyolefin of the first dielectric layer is formed of a polyethylene.

11. The cable of claim 10, wherein the polyethylene of the first dielectric layer is foamed high density polyethylene.

12. The cable of claim 11, wherein the foamed high density polyethylene is mechanically foamed high density polyethylene.

13. The cable of claim 11, wherein the foamed high density polyethylene is chemically foamed high density polyethylene.

14. The cable of claim 1, wherein the first dielectric layer is formed of fluorinated ethylene propylene.

15. The cable of claim 4, wherein the blow ratio is about 45% and the diameter is about 0.073 inches.

16. The cable of claim 15, wherein the second dielectric layer is about 0.00045 inches thick and the conductive tape metal layer is about 0.001 inches thick.

17. The cable of claim 1, wherein the first dielectric layer further comprises high density polyethylene foam having a blow ratio greater than 37% and a diameter defined by
$$d \cdot {10}^{\frac{Z \sqrt{{ϵ}_{r}}}{138}}$$

18. The cable of claim 17, wherein the conductive tape dielectric layer is 0.00045 inches thick and the conductive tape metal layer is 0.001 inches thick.

19. The cable of claim 1, wherein the conductive tape dielectric layer is between 0.00045 inches thick and 0.002 inches thick.

20. The cable of claim 19, wherein the conductive tape dielectric layer is not more than 0.001 inches thick.

21. The cable of claim 20, wherein the conductive tape dielectric layer is about 0.00045 inches thick.

22. The cable of claim 1, wherein the conductive tape metal layer is between 0.0005 inches thick and 0.002 inches thick.

23. The cable of claim 22, wherein the conductive tape metal layer is about 0.001 inches thick.

24. A miniature coaxial cable having a characteristic impedance of about 75 ohms and which substantially meets the specifications of the GR-139-CORE (Issue 1, 1996) standard with respect to electrical parametric requirements, comprising:
a center conductor;
a dielectric layer having a dielectric constant value of less than 1.7;
an outer conductor structure; and
a jacket; wherein
the outside diameter of the miniature coaxial cable is less than 0.122 inches.

25. The cable of claim 24, wherein the center conductor includes copper.

26. The cable of claim 25, wherein the center conductor includes silver plate on the copper.

27. The cable of claim 24, wherein the cable is adapted to be terminated by a 735A connector.

28. The cable of claim 24, wherein the minimum bend radius of the cable is at most 1.22 in.

29. The cable of claim 24, wherein the dielectric layer includes a polyolefin.

30. The cable of claim 29, wherein the polyolefin dielectric layer is formed of a polypropylene.

31. The cable of claim 29, wherein the polyolefin dielectric layer is formed of a polyethylene.

32. The cable of claim 24, wherein the dielectric layer is formed of fluorinated ethylene propylene.

33. The cable of claim 31, wherein the polyethylene of the dielectric layer is foamed high density polyethylene.

34. The cable of claim 33, wherein the foamed high density polyethylene is mechanically foamed high density polyethylene.

35. The cable of claim 33, wherein the foamed high density polyethylene is chemically foamed high density polyethylene.

36. The cable of claim 24, wherein the outer conductor structure includes a metal foil layer and a metal braid layer.

37. The cable of claim 24, wherein the jacket is a PVC jacket.

38. The cable of claim 36, wherein:
the center conductor includes copper with a silver plating;
the dielectric layer includes a layer of chemically foamed high density polyethylene; and
the jacket is polyvinyl chloride.

39. A bundle of coaxial cables enclosed in a jacket, wherein the coaxial cables enclosed are miniature coaxial cables which substantially meet the GR-139-CORE (Issue 1, 1996) standard with respect to electrical parametric requirements having a characteristic impedance of 75 ohms and wherein a miniature cable comprises:
a center conductor; and
a dielectric layer having a dielectric constant value of less than 1.7; and
an outer conductor structure; and
a jacket; wherein
the outside diameter of the miniature coaxial cable is less than 0.122 inches.

40. The bundle of coaxial cables according to claim 39, wherein the jacket enclosing the cables is a PVC jacket.

41. The bundle of coaxial cables according to claim 39, wherein the number of miniature coaxial cables contained in the bundle is at least 2.

42. The bundle of coaxial cables according to claim 41, wherein the number of miniature coaxial cables contained in the bundle is at least 12.

43. The bundle of coaxial cables according to claim 42, wherein the number of miniature coaxial cables contained in the bundle is 24.

44. The bundle of coaxial cables according to claim 39, wherein all of the miniature coaxial cables contained in the bundle have a characteristic impedance of 75 ohms and wherein each miniature cable comprises:
a center conductor; and
a dielectric layer having a dielectric constant value of less than 1.7; and
an outer conductor structure; and
a jacket; wherein
the outside diameter of the miniature coaxial cable is less than 0.122 inches.

45. The bundle of cables according to claim 44, wherein the minimum bend radius of each of the miniature coaxial cables in the bundle is at most 1.22 in.
